(19) United States
(12) Patent Application Publication
(10) Pub. No.: US 2022/0388090 A1
(43) Pub. Date: Dec. 8, 2022

(54) FABRICATION OF THICK STOCK VIA DIFFUSION BONDING OF TITANIUM ALLOYS

(71) Applicant: The Boeing Company, Chicago, IL (US)

(72) Inventors: Ashley A. McKenna, Melbourne, FL (US); Mitchell D. Adducci, St. Louis, MO (US)

(73) Assignee: The Boeing Company, Chicago, IL (US)

(21) Appl. No.: 17/833,127

(22) Filed: Jun. 6, 2022

Related U.S. Application Data
(60) Provisional application No. 63/196,795, filed on Jun. 4, 2021.

(51) Int. Cl. B23K 20/02; B23K 20/00; B23K 20/24; B23K 35/30; B23K 31/12

(52) U.S. Cl. CPC B23K 20/026; B23K 20/002; B23K 20/24; B23K 35/3053; B23K 31/125; B23K 2101/006

(57) ABSTRACT

A method for making a bonded metal piece, including (a) obtaining a first piece of stock metal comprising a first surface and a second piece of the stock metal comprising a second surface; (b) smoothing the first surface so as to form a first contact surface and smoothing the second surface so as to form a second contact surface; (c) cleaning the first contact surface and the second contact surface; (d) loading the first piece and the second piece into a furnace; and (e) bonding the first piece to the second piece so as to form a bonded metal piece comprising the first contact surface diffusion bonded to the second contact surface. The bonding includes (i) heating the first piece and the second piece to a temperature below a superplastic forming temperature of the stock metal; and (ii) applying a pressure comprising pressing the first contact surface and the second contact surface together while the first piece and the second piece are at the temperature. In one or more examples, the bonded metal piece is machined (without forging or working into shape) into an aircraft part.

### CROSS REFERENCE TO RELATED APPLICATIONS

This application claims the benefit under 35 U.S.C. Section 119(e) of co-pending and commonly-assigned U.S. Provisional Patent Application No. 63/196,795, filed Jun. 4, 2021, by Ashley A. McKenna and Mitchell D. Adducci, entitled “FABRICATION OF THICK STOCK VIA DIFFUSION BONDING OF TITANIUM ALLOYS,” Docket No. (21-0173-US-PSP), which application is incorporated by reference herein.

### BACKGROUND

### 1. Field

The present disclosure relates to a method of manufacturing metal parts.

### 2. Description of the Related Art

Titanium (Ti) alloys are used in large aircraft structural parts (e.g., wing skins, wing spars, longerons, and bulkheads) that require high strength performance. Large size and high strength aircraft parts are conventionally manufactured from die forgings. However, the very long lead times (on the order of 60+ weeks) to obtain raw Ti alloy stock, coupled with long lead times to perform the forging, processing, machining, and finishing, severely delay program manufacturing schedules. A conventional solution is to machine, or ‘hog-out’ the part from a rectangular piece of stock such as plate stock. While plate stock is more readily available, this solution only works if there is plate stock available in the required thickness and with sufficient properties for the intended loading of the part. What is needed then, are more versatile manufacturing methods with shorter lead times that also meet the performance requirements for aircraft parts. The present disclosure satisfies this need.

### SUMMARY

Illustrative, non-exclusive examples of inventive subject matter according to the present disclosure are described in the following enumerated paragraphs:

A method for making a bonded metal piece including:

(a) obtaining a first piece of stock metal comprising a first surface and a second piece of the stock metal comprising a second surface;(b) smoothing the first surface so as to form a first contact surface and smoothing the second surface so as to form a second contact surface; (c) cleaning the first contact surface and the second contact surface; (d) loading the first piece and the second piece into a furnace; (e) bonding the first piece to the second piece so as to form a bonded metal piece having the first contact surface bonded to the second contact surface, the bonding including (i) heating the first piece and the second piece to a temperature sufficient for diffusion bonding and below a melting temperature of the stock metal; and (ii) applying a pressure comprising pressing the first contact surface and the second contact surface together while the first piece and the second piece are at the temperature; (h) releasing the pressure and allowing the bonded metal piece to cool; and (i) unloading the bonded metal piece from the furnace.

2. A titanium workpiece having:
a first piece with titanium having a first side;
a second piece with titanium and having a second side; and
a bond with a diffusion bond between an entirety of the first side and an entirety of the second side.

3. A part having an aircraft structure formed from a machined and unforged workpiece, wherein the machined and unforged workpiece including:
a first piece of metal having a first side;
a second piece of the metal having a second side; and
a diffusion bond between an entirety of the first side and an entirety of the second side . A system for fabricating a workpiece, having:
a milling machine configured to smooth a first surface of a first piece so as to form a first contact surface and smoothing the second surface so as to form a second contact surface;
a cleaning station configured to clean the first contact surface and the second contact surface;
a furnace with a press or anvil configured to:
   receive the first piece and the second piece
   bond the first piece to the second piece so as to form the titanium workpiece having the first contact surface bonded to the second contact surface, the bonding including:
   heat the first piece and the second piece to a temperature sufficient for diffusion bonding and below a melting temperature of the metal; and
   apply a pressure pressing the first contact surface and the second contact surface together while the first piece and the second piece are at the temperature; and release the pressure and allow the titanium workpiece piece to cool.

### BRIEF DESCRIPTION OF THE DRAWINGS

In the following description, reference is made to the accompanying drawings which form a part hereof, and which is shown, by way of illustration, several embodiments. It is understood that other embodiments may be utilized and structural changes may be made without departing from the scope of the present disclosure.

FIG. 1 is a flowchart illustrating an example method of manufacturing a bonded metal piece.

FIG. 2A-2C illustrate an example system for manufacturing the bonded metal piece using the method illustrated in FIG. 1, wherein FIG. 2A illustrates a milling machine and cleaning station, FIG. 2B illustrates the press and furnace, and FIG. 2C illustrates the final metal piece.

FIG. 3 is a schematic of an aircraft including aircraft parts manufactured according to the example methods described herein.

FIG. 4A-4D illustrate an example diffusion bonding mechanism, wherein FIG. 4A illustrates surface roughness R of the surfaces prior to bonding, FIG. 4B illustrates micro-asperity deformation, FIG. 4C illustrates diffusion-controlled mass transport induced by application of pressure and temperature, and FIG. 4D illustrates creation of a diffusion bond.

### TECHNICAL DESCRIPTION

Titanium (Ti) alloys are frequently used for aircraft structural parts that require high strength performance. These parts tend to be very large. Titanium and other metal stock require long lead times for die forging, processing, machining and finishing. Also, some alloys are not available in stocks, such as plate form, in the thickness and with properties necessary for parts loading.

Conventional Ti (Titanium) alloys and other metal stock sizes used for structural parts are limited by the trade-off between thickness and mechanical properties. Titanium and other metals achieves its strength based on the amount of work (via rolling or forging) applied to the Ti or other metal; thick rolled or wrought stock inherently receives less work than thin sheet products.

The present disclosure describes methods of manufacturing thicker stock size metal pieces with improved properties as compared to metal pieces manufactured using conventional wrought processes such as a rolling plate process. The method comprises diffusion bonding two pieces of metallic plate stock to form a single, thicker piece of plate stock than is otherwise capable of being produced from the traditional method of rolling plate. Moreover, exemplary methods described herein enable manufacturing of the thicker plate having the properties of the two thinner plates (in contrast to rolled plate which is characterized by lower material properties as the cross section of the part is increased).

Example applications of the thicker stock metal pieces manufactured using the methods described herein include, but are not limited to, manufacture of large and thick sectioned structural parts conventionally machined from die forgings, or stock for machined parts that otherwise have long lead times or costly non-recurring expenses to produce from a different stock form (e.g. formed by forging or extrusion, for example).
Example Method of Manufacturing a Bonded Metal Piece

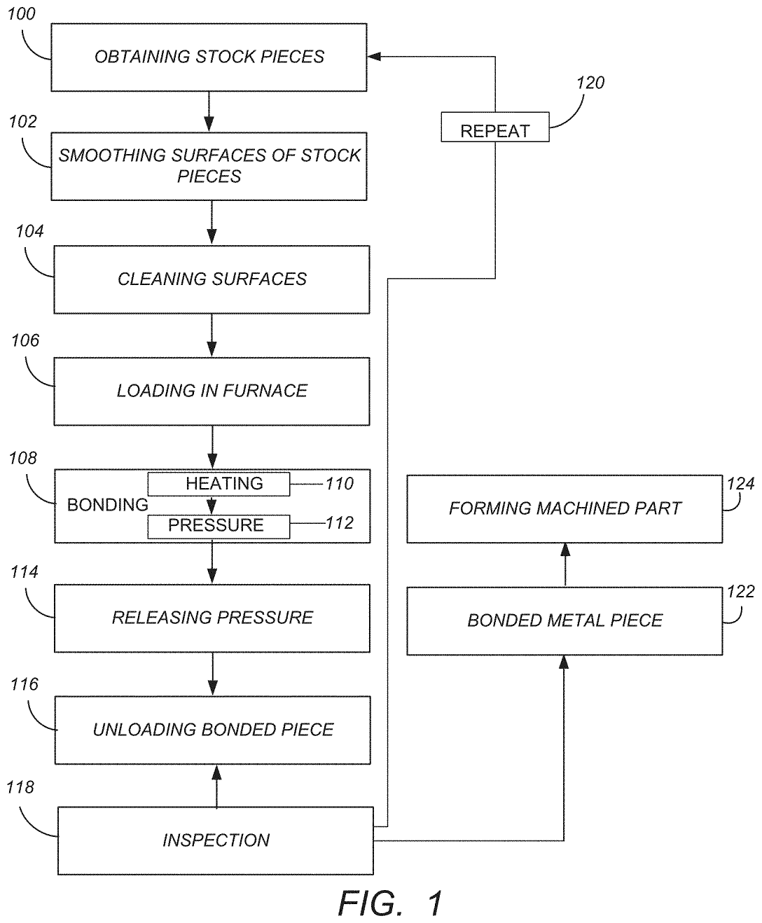

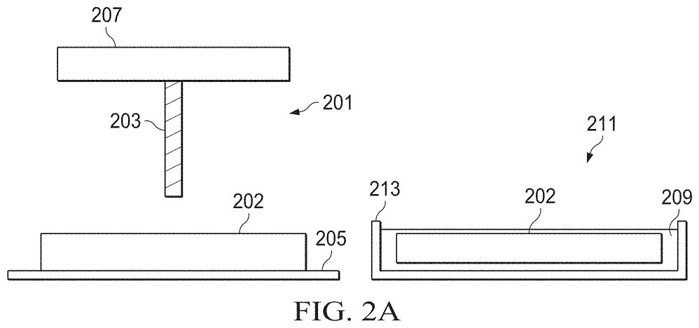

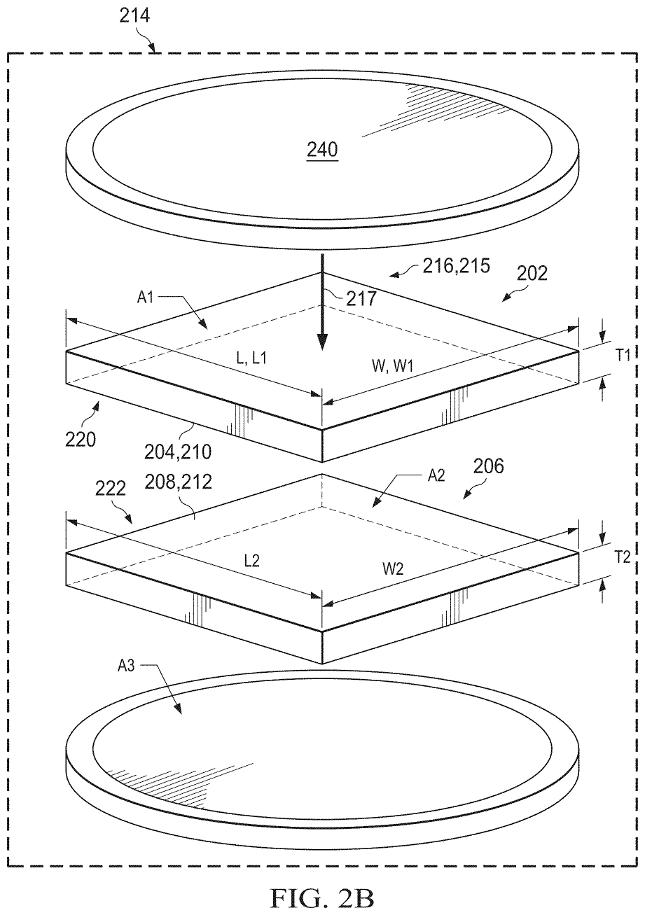

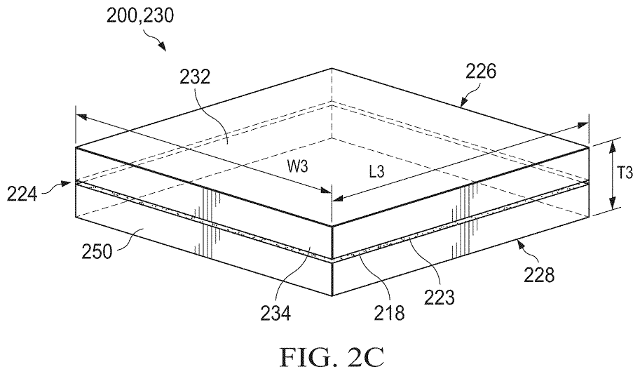

FIG. 1 illustrates a method for manufacturing the bonded metal piece (200) or workpiece (230) illustrated in FIG. 2C using the system illustrated in FIGS. 2A-2B. The method comprises the following steps.

Block 100 represents obtaining a first piece (202) of stock metal, comprising a first surface (204), and obtaining a second piece (206) of the stock metal, comprising a second surface (208).

In one or more examples, the first piece (202) comprises a first plate (226) having a first thickness T1 of a non-zero value of about 4 inches or less, and the second piece (206) comprises a second plate (228) having a second thickness T2 of a non-zero value of about 4 inches or less. In yet further examples, the first plate (226) and the second plate (228) each independently have a length L1, L2, respectively, defining surface areas Al, A2 of the first plate (226) and the second plate (228) that are equal to or smaller than a surface area A3 of the press (240) being used to apply the pressure in block 112. In some examples, the first plate (226) and the second plate (228) each independently have a length L1, L2, respectively, of from about 0.5 feet to about 8 feet, or from about 1 foot to about 8 feet, or from about 2 feet to about 8 feet and a width W1, W2, respectively, in a range of from about 0.5 feet to about 5 feet, or from about 1 foot to about 5 feet, or from about 2 feet to about 5 feet. In one or more examples, the first plate (226) and the second plate (228) each independently have a surface area A1, A2 equal to or less than 5 feet by 8 feet. In one or more examples, the first surface (204) comprises a first rectangular cross-sectional area (232), the second surface (208) comprises a second rectangular cross-sectional area (234), the first plate (226) and the second plate (228) each comprise a rectangular prism having a rectangular cross-section, and the thicknesses T1, T2 are uniform across the entire respective lengths L1, L2 and respective widths W2, W1 (e.g., the thicknesses T1, T2 are uniform to within 1% or within 0.5%).

In one or more examples, the metal comprises or consists essentially of titanium (e.g., commercial pure (CP) Ti) or a titanium alloy. In one or more examples, “consisting essentially of titanium” or “consisting essentially of a titanium alloy” is defined as the pieces (202, 206) of stock metal containing substantially (e.g. at least 90%) or 100% titanium such that the properties of the pieces (202, 206) are substantially (e.g., 100% or at least 90%) determined by the properties of titanium. In some examples, the stock metal comprises a titanium alloy including titanium and at least one metal selected from vanadium, aluminum, zinc, tin, or molybdenum. In one or more examples, the titanium alloy comprises least 90% or at least 80% titanium and with the remaining percentage (e.g., 10% or less or 20% or less) comprising other metals. Examples of titanium alloys include, but are not limited to, Ti—6 V—4 Al, Ti—6 V—4 Al ELI (Extra Low Interstitial), and Ti—6 V—2 Sn—4 Zn—2 Mo.

In other examples, the metal comprises or consists of other alloys that can be diffusion bonded, including but not limited to, at least one metal comprising or consisting essentially of aluminum, an aluminum alloy, nickel, a nickel based alloy, zirconium, a zirconium alloy, copper, or a copper alloy.

In one or more examples, the first piece (202) comprises at least one of a first unforged piece, a first stock piece, or a first billet and the second piece (206) comprises at least one of a second unforged piece, a second stock piece, or a second billet. In one or more examples, a stock piece is defined as a raw purified metal used by industry to Manufacture metal parts and products.

Block 102 represents smoothing the first surface (204) so as to form a first contact surface (210), and smoothing the second surface (208) so as to form a second contact surface (212). In one or more examples, the smoothing forms at least one of the first contact surface (210) or the second contact surface (212) having an average surface roughness R comprising a non-zero value less than 1 micrometer over the entire surface area of the contact surfaces (210, 212). In one or more examples, the smoothing is performed in a milling machine (201) (FIG. 2A) that precision mills the faces (first surface (204) and second surface (208)) of the stock metal pieces (202, 206) using a cutter (203), so as to form the first contact surface (210) and the second contact surface (212). As illustrated in FIG. 2A, the milling machine comprises a work table (205) supporting the pieces (202, 206) of stock metal and a head (207) positioning the cutter (203) on the surfaces (204, 208) to perform the smoothing.

Block 104 represents cleaning the first contact surface (210) and the second contact surface (212). In one or more examples, the cleaning removes one or more contaminants that would undesirably degrade the quality of the diffusion bond formed in step (108) or degrade the properties of the manufactured bonded metal piece (202) as compared to the properties of the first piece (202) and the second piece (204). In one or more examples, the cleaning (e.g., pickling or etching) is performed by contacting the surfaces (204, 208) with a cleaning agent (209) (e.g., a solvent, an acid, or a pickling liquor) that removes the contaminants. FIG. 2A illustrates an example cleaning station (211) comprising a bath (213) immersing the surfaces (204, 208) in the cleaning agent (209). In other examples, the cleaning station (211) comprises a system of nozzles configured to spray the surfaces (204, 208) with the cleaning agent (209).

In one or more examples, the method includes an optional step, after the cleaning in Block 104, of applying a brazing filler or brazing alloy (218) (FIG. 2C) to at least one of the first contact surface (210) or the second contact surface (212). Example brazing techniques are described in U.S. Pat. No. 5,420,400.

Block 106 represents loading the first piece (202) and the second piece (206) into a furnace (214) comprising a press (240) (e.g., comprising a platform having a surface area A3).

Block 108 represents bonding (108) the first piece (202) to the second piece (206) so as to form a bonded metal piece (200) comprising the first contact surface (210) bonded to the second contact surface (212). The bonding (108) comprises:
(i) heating (block 110) the first piece (202) and the second piece (206) to a temperature (215) sufficient for diffusion bonding and below a melting temperature (216) of the stock metal. In yet further examples, the heating (block 110) the first piece (202) and the second piece (206) is to a temperature (215) below a temperature for achieving beta Transus of the stock metal. Example temperatures (215) include, but are not limited to, a temperature T in a range 500° C.≤T≤940° C., 600° C.≤T≤940° C., 700° C.≤T≤940° C., 800° C.≤T≤940° C., 825° C.≤T≤940° C., or 830° C.≤T≤940° C.; and
(ii) applying (Block 112) a pressure (217), comprising pressing the first contact surface (210) and the second contact surface (212) together while the first piece (202) and the second piece (206) are held at the temperature (215) below the melting temperature (216)

Example pressures include a pressure sufficient to provide intimate contact between the contact surfaces (210, 212) of the pieces (202, 206). In one or more examples, the pressure depends on the temperature (215) and the duration of time over which the pressure is applied. Example pressures (217) include, but are not limited to, a pressure P in a range 0.5 megapascals (MPa)≤P≤5 MPa, 1 MPa≤P≤5 MPa, 2≤P≤5 MPa, 3 MPa≤P≤5 MPa, or 4≤P≤5 MPa, or pressures resulting from a tonnage of 1200 tons or less applied to the press (240). In one or more further examples, the pressure is sufficiently high and applied sufficiently uniformly (e.g., pressure variations are within 5%) across the entire contact surfaces (210, 212) so as to achieve a diffusion bond (223) across the entire interface (224) between the contact surfaces (210, 212).

In one or more examples, the heating includes preheating and/or ramping the furnace to the required temperature (215) after loading the pieces (202, 206) in the furnace (214) and prior to applying the pressure (217).

In one or more examples, the pressure (217) and temperature (215) are applied for a duration in a range of 30 minutes-24 hours.

Block 114 represents releasing (114) the pressure (217) and allowing the bonded metal piece (200) to cool.

Block 116 represents unloading the bonded metal piece (200) from the furnace (214).

Block 118 represents inspecting and testing at least one property of the bonded metal piece (200). Example properties include, but are not limited to, a mechanical property (e.g., lot mechanical property) or an electrical property. The inspecting comprises determining whether a value of the at least one property is degraded as compared to one or more stock values of the at least one property for the first piece (202) and the second piece (206) (i.e., prior to implementing the methods described herein). Example inspection methods include, but are not limited to, measuring the at least one property using ultrasound, stress-strain characterization, fracture toughness, and radiographic inspection.

Block 120 represents optionally repeating the steps of Blocks 100-118 when the value of the at least one property is degraded as compared to the stock values. The bonding in the subsequent step(s) uses at least one of a smoother one of the first contact surface (210), a smoother one of the second contact surface (212), a cleaner one of the first contact surface (210) having a reduced level of contaminants that degrade the bonding, or a cleaner one of the second contact surface (212) having a reduced level of contaminants that degrade the bonding.

Block 122 represents the bonded metal piece (200) or workpiece (230) formed by the steps 100-120. In one or more examples, the bonded metal piece (200) has a thickness T3=T1+T2, a length L3, and a width W3. In one or more examples, L3=L2=L1 and W3=W1=W2. In other examples, L3 is about equal to the largest of L2 and L1 and W3 is equal to the largest of W2 and W1. In yet further examples, the bonded metal piece (200) comprises a rectangular prism or rectangular plate having a rectangular cross-section (250) formed by the first piece (202) stacked on the second piece (206). In one or more examples, the bonded metal piece (200) comprises a bond (223) comprising a planar interface (224) between the entirety of the first side (220) of the first piece (202) and the entirety of the second side (222) of the second piece (206). Example workpieces (230) include stock metal that can be machined, formed or manufactured into a part.

As described herein, in one or more examples, the bonded metal piece (200) is manufactured without superplastic forming. Superplastic forming is defined as a process applying sufficiently high temperatures to the pieces (202, 206) so that the material in the pieces (202, 206) flows, and deforming the pieces (202, 206) in their superplastic state, e.g., using plastic forming techniques such as, but not limited to, thermoforming, blow forming, vacuum forming or using an inert gas pressure applied on at least one of the superplastic pieces (202, 206) that forces at least one of the surfaces (204, 208) into a female die. The term superplasticity is defined according to its usual meaning in the art, that of the ability of a polycrystalline material to exhibit, in a generally isotropic manner, very high tensile elongation prior to failure. Whether superplastic flow has been induced in a material can be measured by any known method in the art, such as the Active Standard ASTM E2448 (standard test method for determining the superplastic properties of metallic sheet materials).

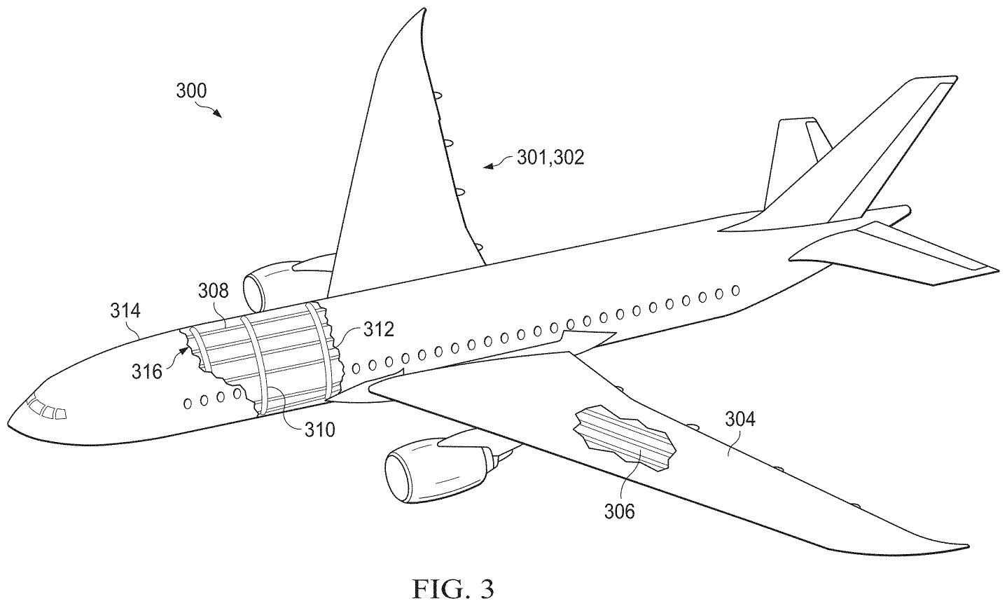

Block 124 represents optionally forming the bonded metal piece (200) or workpiece (230) into a machined part (301), as illustrated in FIG. 3. In typical examples, the forming comprises machining but does not include forging.
Example Aircraft Parts Manufactured Using the Method

FIG. 3 is a schematic of an aircraft (300) comprising aircraft parts (302) manufactured and formed using the method illustrated in FIG. 1. FIG. 3 illustrates example aircraft parts (302) include, but are not limited to, a wing skin (304), a wing spar (306), a longeron (308), bulkhead (310), a bulkhead (310) piece (312), or a fuselage (314) section (316).
Example Diffusion Bonding Mechanism

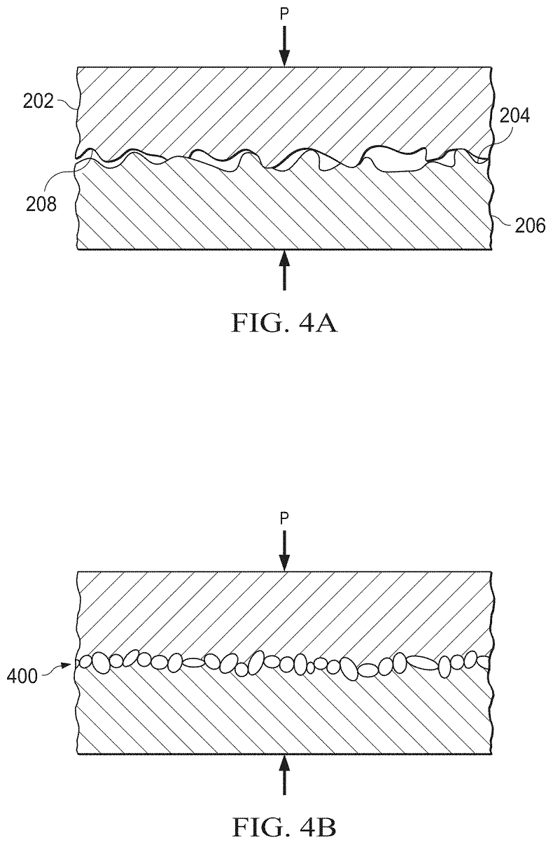

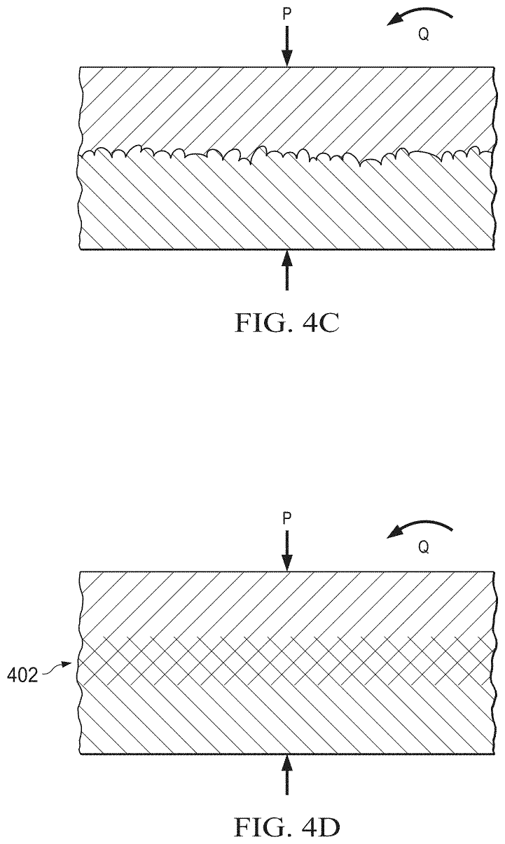

FIGS. 4A-4D illustrate an example diffusion bonding process wherein the atoms of the two solid, metallic surfaces (204, 208) intersperse themselves over time according to solid state diffusion. In various examples, the diffusion bonding is achieved at a temperature of up to 90% of the melting temperature of the material in the pieces (202, 206) being bonded. FIG. 4A-4D illustrate various stages of the diffusion bonding process, wherein FIG. 4A illustrates surface roughness R of the surfaces prior to bonding, FIG. 4B illustrates micro-asperity deformation wherein, before the surfaces (204, 208) completely contact, asperities (400) comprising small surface defects on the two surfaces (204, 208) contact and plastically deform and interlink so as to form interfaces between the two surfaces (204, 208), FIG. 4C illustrates diffusion-controlled mass transport induced by application of the pressure (217) and the temperature (215) causing heat input Q, characterized by accelerated creep in the materials, migration of grain boundaries, and reduction of gaps between the two surfaces to isolated pores; and FIG. 4D illustrates interface migration such that the metal diffuses across the boundaries of the surfaces (204, 208) causing blending the boundaries between the pieces (202, 206) and the creation of a diffusion bond (402) between the pieces (202, 206).
Example Articles, Systems, and Methods According to the Present Disclosure

Illustrative, non-exclusive examples of inventive subject matter according to the present disclosure are described in the following enumerated Clauses:

1. A method for making a bonded metal piece (200) or workpiece (230), comprising:
(a) obtaining (100) a first piece (202) of stock metal comprising a first surface (204) and a second piece (206) of the stock metal comprising a second surface (208);
(b) smoothing (102) the first surface (204) so as to form a first contact surface (210) and smoothing (102) the second surface (208) so as to form a second contact surface (212);
(c) cleaning (104) the first contact surface (210) and the second contact surface (212);
(d) loading (106) the first piece (202) and the second piece (206) into a furnace (214);
(e) bonding (108) the first piece (202) to the second piece (206) so as to form a bonded metal piece (200) comprising the first contact surface (210) bonded to the second contact surface (212), the bonding (108) comprising: (i) heating (110) the first piece (202) and the second piece (206) to a temperature (216) below a melting temperature (216) of the stock metal; and (ii) applying (112) a pressure (217) comprising pressing the first contact surface (210) and the second contact surface (212) together while the first piece (202) and the second piece (206) are at the temperature (216);
(f) releasing (114) the pressure (217) and allowing the bonded metal piece (200) to cool; and
(g) unloading (116) the bonded metal piece (200) from the furnace (214).

2. The method of Clause 1, wherein the temperature T is 800° C.≤T≤940° C.

3. The method of Clause 1 or Clause 2, further comprising, after the cleaning in (c), applying brazing filler or brazing alloy (218) to at least one of the first contact surface (210) or the second contact surface (212) so that the bonded metal piece (200) comprises the first contact surface (210) bonded to the second contact surface (212) using the brazing filler or brazing alloy (218).

4. The method of any of the Clauses 1-3, wherein the brazing alloy (218) comprises steel.

5. The method of any of the Clauses 1-3, further comprising after (g) inspecting (118) at least one property of the bonded metal piece (200), wherein:
the at least one property is a mechanical property or an electrical property, and
the inspecting comprises determining whether a value of the at least one property is degraded as compared to one or more stock values of the at least one property for the first piece (202) and the second piece (206).

6. The method of Clause 5, wherein the inspecting (118) comprises measuring the at least one property using ultrasound.

7. The method of Clauses 5 or 6, further comprising repeating steps (a)-(g) when the value of the at least one property is degraded as compared to the stock values, wherein the bonding in the repeating step uses at least one of:
a smoother one of the first contact surface (210),
a smoother one of the second contact surface (212),
a cleaner one of the first contact surface (210) having a reduced level of contaminants that degrade the bonding, or
a cleaner one of the second contact surface (212) having a reduced level of contaminants that degrade the bonding.

8. The method of any of the Clause 1-7, wherein at least one of the first contact surface (210) or the second contact surface (212) have a non-zero surface roughness less than 1 micrometer.

9. The method of any of the Clauses 1-8, wherein:
the first contact surface (210) extends across an entirety of a first side (220) of the first piece (202) and the second contact surface (212) extends across an entirety of a second side (222) of the second piece (206), and

the bonded metal piece (200) comprises a bond (223) comprising an interface (224) between the entirety of the first side (220) and the entirety of the second side (222).

10. The method of any of the Clauses 1-9, wherein:
the first piece (202) comprises a first plate (226) comprising a first thickness T1 of a non-zero value of about 4 inches or less;
the second piece (206) comprises a second plate (228) comprising a second thickness T2 of a non-zero value of about 4 inches or less.

11. The method of any of the Clauses 1-10, wherein the first plate (226) and the second plate (228) each have a length L in a range of from about 0.5 feet to about 8 feet and a width W in a range of from about 0.5 feet to about 5 feet.

12. The method of any of the Clauses 10-21, wherein the bonded metal piece (200) has a thickness T3=T1+T2, a length L3, and a width W3 and:
L3=L2=L1 and W3=W1=W2=W3, or
L3 is about equal to the largest of L2 and L1 and W3 is equal to the largest of W2 and W1.

13. The method of any of the Clauses 1-12, wherein the bonded metal piece (200) comprises a rectangular prism or rectangular plate having a rectangular cross-section (250) formed by the first piece (202) stacked on the second piece (206).

14. The method of any of the Clauses the bonded metal piece (200) comprises an interface (224) between the first side (220) and the second side (222), and the interface (224), the first side (220), and the second side (222) are planar across an entirety of the first side (220) and an entirety of the second side (222).

15. The method of any of the Clauses 1-14, wherein the metal comprises or consists essentially of titanium.

16. The method of any of the Clauses 1-15, wherein the first piece (202) comprises at least one of a first unforged piece, a first stock piece, or a first billet and the second piece (206) comprises at least one of a second unforged piece, a second stock piece, or a second billet.

17. The method of any of the Clauses 1-16, further comprising forming (120) the bonded metal piece (200) into a machined part, wherein the forming comprises machining but does not include forging.

18. The method of Clause 17, wherein the machined part (301) comprises an aircraft (300) part (302).

19. The method of Clause 15, wherein the aircraft part (302) comprises a wing skin (304) 304, a wing spar (306), a longeron (308), a bulkhead (310), bulkhead (310) piece 312, or a fuselage (314) section (316).

20. A workpiece comprising the bonded metal piece (202) manufactured using the method of any of the Clauses 1-19.

21. A (e.g., titanium) workpiece (230), comprising:

a first piece (202) comprising or consisting essentially of titanium having a first side (220);

a second piece (206) comprising titanium or consisting essentially of titanium and having a second side (222); and

a bond (223) comprising a diffusion bond (402) between an entirety of the first side (220) and an entirety of the second side (222).

22. The workpiece (230) of Clause 21, wherein:
the first piece (202) comprises a first plate (226) comprising a first thickness T1 of a non-zero value of about 4 inches or less and the first side (220) comprises a first area having a first length L1 in a range of from about 8 feet to about 20 feet and a first width W1 in a range of from about 5 feet to about 10 feet; and

the second piece (206) comprises a second plate (228) comprising a second thickness T2 of a non-zero value of about 4 inches or less and the second side (222) comprises a second area having a second length L2 in a range of from about 0.5 feet to about 8 feet and a second width W2 in a range of from about 0.5 feet to about 5 feet.

23. The workpiece (230) of Clause 21 or 22, wherein the bond (223) across the entirety of the first side (220) and the second side (222) is sufficient to form the workpiece (230) characterized by at least one property selected from a mechanical property and an electrical property having values that are not degraded as compared to stock values of the at least one property for the first piece and the second piece.

24. The workpiece (230) of any of the Clauses 21-23, wherein the workpiece (230) has a thickness T3=T1+T2, a length L3, and a width W3 and:
L3=L2=L1 and W3=W1=W2=W3, or
L3 is about equal to the largest of L2 and L1 and W3 is equal to the largest of W2 and W1.

25. The workpiece (230) of any of the Clauses 21-24, wherein the workpiece (230) comprises a rectangular prism or rectangular plate having a rectangular cross-section (250) formed by the first piece (202) stacked on the second piece (206).

26. The workpiece (230) of any of the Clauses 21-26 wherein the diffusion bond (402) comprises an interface (224) between the first side (220) and the second side (222) and the interface (224), the first side (220), and the second side (222) are planar across an entirety of the first side (220) and an entirety of the second side (222).

27. The workpiece (230) of any of the Clauses 23-26, wherein the mechanical property comprises at least one of tensile strength, yield strength or fracture toughness and the electrical property comprises an electrical conductivity.

28. An aircraft part (302) formed, from the workpiece (230) of any of the Clauses 21-27, by machining but without forging.

29. The workpiece (230) of any of the Clauses 21-28 formed using a process comprising:
(a) obtaining (100) the first piece having a first surface (204) and the second piece having a second surface (208);
(b) smoothing (102) the first surface (204) so as to form a first contact surface (210) and smoothing the second surface (208) so as to form a second contact surface (212);
(c) cleaning (104) the first contact surface (210) and the second contact surface (212);
(d) loading (106) the first piece (202) and the second piece (206) into a furnace (214);
(e) bonding (108) the first piece (202) to the second piece (206) so as to form the titanium workpiece (230) comprising the first contact surface (210) bonded to the second contact surface (212), the bonding (108) comprising:
(i) heating (110) the first piece (202) and the second piece (206) to a temperature (215) below a superplastic forming temperature (216) of the titanium;
(ii) applying (112) a pressure (217) pressing the first contact surface (210) and the second contact surface (212) together while the first piece (202) and the second piece (206) are at the temperature (216);
(f) releasing (114) the pressure (217) and allowing the titanium workpiece (230) piece to cool; and
(g) unloading (116) the titanium workpiece (230) from the furnace (214).

30. The workpiece (230) of any of the Clauses 21-29 formed using the method of any of the Clauses 1-20.

31. A part comprising an aircraft structure formed from a machined and unforged workpiece (230), wherein the machined and unforged workpiece (230) comprises:
a first piece (202) of metal having a first side (220);
a second piece (206) of the metal having a second side (222); and
a diffusion bond (223) between an entirety of the first side (220) and an entirety of the second side (222).

32. The workpiece (230) of any of the Clauses 21-31 comprising or consisting essentially of titanium.

33. A system for fabricating a workpiece (230), comprising:
a milling machine (201) configured to smooth (102) a first surface (204) of a first piece so as to form a first contact surface (210) and smoothing the second surface (208) so as to form a second contact surface (212);
a cleaning station (211) configured to clean the first contact surface (210) and the second contact surface (212);
a furnace (214) comprising a press (240) or anvil configured to:
(i) receive the first piece (202) and the second piece (206) (ii) bond (108) the first piece (202) to the second piece (206) so as to form the titanium workpiece (230) comprising the first contact surface (210) bonded to the second contact surface (212), the bonding (108) comprising:
(i) heat (110) the first piece (202) and the second piece (206) to a temperature (216) below a superplastic forming temperature (216) of the metal; and
(ii) apply (112) a pressure (217) pressing the first contact surface (210) and the second contact surface (212) together while the first piece (202) and the second piece (206) are at the temperature (216); and
release (114) the pressure (217) and allow the titanium workpiece (230) piece to cool.

34. The system of Clause 33, wherein the surfaces of the press in contact with the first piece and the second piece during application of the pressure consist essentially of planar surfaces (e.g., the planar surfaces do not contain any grooves or cavities used to bend the pieces).

35. The workpiece of any of the Clauses 21-32 manufactured using the system of Clause 27.

36. The method of any of the Clauses 1-20 performed using the system of Clauses 33 or 34.

37. A method of manufacturing a thicker plate, comprising joining together two or more thinner plates (226, 228) stacked on top of one another by diffusion bonding to create a single, thicker piece of stock.
38. The method of Clause 37, wherein the individual thinner pieces (202, 206) prior to bonding have more desirable starting properties than a single piece of stock rolled to the greater thickness T3 of the thicker piece of stock (bonded metal piece (200)), and the final diffusion bonded material in the thicker piece of stock (bonded metal piece (200)) has the same properties as the thinner plates (202, 206).

39. The method or workpiece of any of the Clauses 1-38, wherein the workpiece (230) or bonded metal piece (202) is not super plastically formed and is not characterized by having superplastic properties.

40. The method of any of the Clauses 1-39, wherein the method does not include forging, molding, bending, or deformation of the pieces (202, 206) using a gas or fluid pressure applied to the contact surfaces e.g., so as to force the pieces (202, 206) into a die.

41. The workpiece (230) or bonded metal piece (200) formed using the method of any of the Clauses 1-20 or, wherein the method stacks the pieces (202, 206) to form the workpiece (230) or bonded metal piece (200) having a thickness T3=T1+T2 across the entire length L3 and width W3 without substantially changing a shape of, or without deforming, the pieces (202, 206).

Conclusion

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. A method for making a bonded metal piece, comprising:
(a) obtaining a first piece of stock metal comprising a first surface and a second piece of the stock metal comprising a second surface;
(b) smoothing the first surface so as to form a first contact surface and smoothing the second surface so as to form a second contact surface;
(c) cleaning the first contact surface and the second contact surface;
(d) loading the first piece and the second piece into a furnace;
(e) bonding the first piece to the second piece so as to form a bonded metal piece comprising the first contact surface bonded to the second contact surface, the bonding comprising:
(i) heating the first piece and the second piece to a temperature below a superplastic forming temperature of the stock metal; and
(ii) applying a pressure comprising pressing the first contact surface and the second contact surface together while the first piece and the second piece are at the temperature;
(f) releasing the pressure and allowing the bonded metal piece to cool; and
(g) unloading the bonded metal piece from the furnace.

2. The method of claim 1, wherein the temperature T is 800° C.≤T≤940° C.

3. The method of claim 1, further comprising, after the cleaning in (c), applying a brazing filler to at least one of the first contact surface or the second contact surface so that the bonded metal piece comprises the first contact surface bonded to the second contact surface using the brazing filler.

4. The method of claim 3, wherein the brazing filler comprises steel.

5. The method of claim 1, further comprising after (g) inspecting at least one property of the bonded metal piece, wherein:
the at least one property is a mechanical property or an electrical property, and
the inspecting comprises determining whether a value of the at least one property is degraded as compared to one or more stock values of the at least one property for the first piece and the second piece.

6. The method of claim 5, wherein the inspecting comprises measuring the at least one property using ultrasound.

7. The method of claim 5, further comprising repeating steps (a)-(g) when the value of the at least one property is degraded as compared to the one or more stock values, wherein the bonding in the repeating steps use at least one of:
a smoother one of the first contact surface,
a smoother one of the second contact surface,
a cleaner one of the first contact surface having a reduced level of contaminants that degrade the bonding, or
a cleaner one of the second contact surface having a reduced level of contaminants that degrade the bonding.

8. The method of claim 7, wherein at least one of the first contact surface or the second contact surface have a non-zero surface roughness less than 1 micrometer.

9. The method of claim 1, wherein:
the first contact surface extends across an entirety of a first side of the first piece and the second contact surface extends across an entirety of a second side of the second piece, and
the bonded metal piece comprises a bond comprising an interface between the entirety of the first side and the entirety of the second side .

10. The method of claim 1, wherein:
the first piece comprises a first plate comprising a first thickness T1 of a non-zero value of about 4 inches or less;
the second piece comprises a second plate comprising a second thickness T2 of a non-zero value of about 4 inches or less.

11. The method of claim 10, wherein the first plate and the second plate each have a length L in a range of from about 0.5 feet to about 8 feet and a width W in a range of from about 0.5 feet to about 5 feet.

12. The method of claim 1, wherein the stock metal comprises or consists essentially of titanium.

13. The method of claim 1, wherein the first piece comprises at least one of a first unforged piece, a first stock piece, or a first billet and the second piece comprises at least one of a second unforged piece, a second stock piece, or a second billet.

14. The method of claim 1, further comprising forming the bonded metal piece into a machined part, wherein the forming comprises machining but does not include forging.

15. The method of claim 14, wherein the machined part comprises an aircraft part.

16. The method of claim 15, wherein the aircraft part comprises a wing skin, a wing spar, a longeron, a bulkhead, bulkhead piece, or a fuselage section.

17. A titanium workpiece, comprising:
a first piece comprising or consisting essentially of titanium having a first side;
a second piece comprising titanium or consisting essentially of titanium and having a second side; and
a bond comprising a diffusion bond between an entirety of the first side and an entirety of the second side.

18. The titanium workpiece of claim 17, wherein:
the first piece comprises a first plate comprising a first thickness T1 of a non-zero value of about 4 inches or less and the first side comprises a first area having a first length L1 in a range of from about 8 feet to about 20 feet and a first width W1 in a range of from about 5 feet to about 10 feet;
the second piece comprises a second plate comprising a second thickness T2 of a non-zero value of about 4 inches or less and the second side comprises a second area having a second length L2 in a range of from about 0.5 feet to about 8 feet and a second width W2 in a range of from about 0.5 feet to about 5 feet.

19. The titanium workpiece of claim 17, wherein the bond across the entirety of the first side and the second side is sufficient to form the titanium workpiece characterized by at least one property selected from a mechanical property and an electrical property having values that are not degraded as compared to stock values of the at least one property for the first piece and the second piece.

20. The titanium workpiece of claim 19, wherein the mechanical property comprises at least one of tensile strength, yield strength or fracture toughness and the electrical property comprises an electrical conductivity.
